(19) United States
(12) Patent Application Publication
(10) Pub. No.: US 2017/0292665 A1
(43) Pub. Date: Oct. 12, 2017

(54) UNIVERSAL LIGHTING SYSTEM

(71) Applicant: Larry Sherman, Saint Louis, MO (US)

(72) Inventor: Larry Sherman, Saint Louis, MO (US)

(21) Appl. No.: 15/483,874

(22) Filed: Apr. 10, 2017

Related U.S. Application Data
(60) Provisional application No. 62/320,568, filed on Apr. 10, 2016.

(51) Int. Cl. F21S 9/03; F21S 8/08; F21V 31/00; F21S 9/02; F21V 23/00

(52) U.S. Cl. CPC F21S 9/035; F21S 9/026; F21V 23/003; F21V 31/00; F21S 8/086; F21Y 2115/10

(57) ABSTRACT

A Universal Lighting System is a lighting system powered by solar panels and a wind turbine that may attachably mount to different load bearing members such as light poles. The present invention may have a light source, at least one solar panel, a wind turbine, at least one power storage member, a control panel, and a mounting frame. The components of the present invention may be water proof and may require no maintenance once installed.

### CROSS-REFERENCE TO RELATED APPLICATION

The present application is related to and claims priority from prior provisional application Ser. No. 62/320,568, filed Apr. 10, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of renewable energy powered devices and more specifically relates to universal lighting system.

### DESCRIPTION OF THE RELATED ART

Outdoor lighting for homes, buildings, and businesses are often stationary and are powered by the electrical grid. Powering conventional lighting has continued operation and maintenance costs as well as impacts on the environment. These costs add to the taxes that the general taxpayer has to pay. A street light is a light fixture attached to the top of a pole beside a roadway or walkway designed to illuminate an area of the road or walkway. Street lights are located in places where they can be connected to the electrical grid, but often there is a need for streetlights in areas that the power grid has not been extended into. As such, there is a need for an innovation that could supply street lighting in areas where the power grid does not exist.

Various attempts have been made to solve the above-mentioned problems such as those found in U.S. Pub. No. 2010/0220467 to Paul D. Daidone; U.S. Publication No. 2015/0043200 to Oswald A. Wilson; and U.S. Publication No. 2011/0089698 to William Ahmadi. None of the above inventions and patents, taken either singly or in combination, is seen to describe the invention as claimed.

Ideally, a renewable energy powered device should provide nearly cost free operating expense, and yet, would operate reliably and be manufactured at a modest expense. Thus, a need exists for a reliable universal lighting system to avoid the above-mentioned problems.

### BRIEF SUMMARY OF THE INVENTION

In view of the foregoing disadvantages inherent in the known renewable energy powered device art, the present invention provides a novel universal lighting system. The general purpose of the present invention, which will be described subsequently in greater detail, is to provide nearly cost free operating expense.

A universal lighting system may comprise a mounting frame releasably attachable to a supporting structure, a light member attached to the mounting frame, at least one solar panel member attached to the mounting frame that is electrically connected to the light member to thereby provide electric power thereto, and a wind turbine member attached to the mounting frame that is electrically connected to the light member to thereby provide electric power thereto.

A power storage member is attached to the mounting frame and is electrically connected to the light member for storing operating power. The solar panel member(s) and the turbine member are able to generate power to be to be stored in the power storage member and used by the light member. A control panel is attached to the mounting frame and is electrically connected to the light member, the solar panel member(s), the turbine member, and the power storage member, such that electrical power can be controlled between the devices to optimally charge the power storage unit with incoming power generated by the solar panel member and the turbine members during daylight hours and to provide output power only during the dark hours.

The light member is formed as a light emitting diode. The power storage member is formed as a rechargeable battery member and the rechargeable battery member is formed from the group of rechargeable battery members consisting of lithium ion batteries, lithium polymer batteries, lead acid batteries, nickel-metal hydride batteries, and nickel cadmium batteries. The light member is attached to a lower section of the mounting frame and the solar panel member(s) is attached to a top section of the mounting frame. There may be a plurality of solar panel members attached to top and side sections of the mounting frame in locations where more charging is needed. The wind turbine may be attached to the top section of the mounting frame or may be concentrically and rotationally attached within the axis of the supporting structure.

The control panel includes computer circuitry including computer software thereon adapted to control the amount of power provided from the solar panel(s) and the wind turbine member to the light member, and is adapted to obtain, calculate, and provide power storage information. The control panel is attached to a back section of the mounting frame. The mounting frame has a substantially cylindrical shape adapted to be releasably mounted to a light pole. The mounting frame is formed from a material chosen from the group of materials consisting of aluminum, steel, plastic, and ceramic and the light emitting diode is formed from a waterproof material. In some embodiments, the system may include WiFi connectability and include a camera system for transmitting camera images to a base unit at a second location. In addition, the System could utilize an internet based phone system for emergency calls from remote locations.

The present invention holds significant improvements and serves as a universal lighting system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, universal lighting system, constructed and operative according to the teachings of the present invention.

FIG. 1 shows a perspective view illustrating a universal lighting system according to an embodiment of the present invention.

FIG. 2 is a perspective view illustrating the universal lighting system according to an embodiment of the present invention of FIG. 1.

FIG. 3 is a perspective view illustrating a second embodiment of the universal lighting system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a renewable energy powered devices and more particularly to a universal lighting system as used to make the lighting system nearly cost free.

Generally speaking, a Universal Lighting System is a lighting system powered by solar panels and a wind turbine that may attachably mount to different load bearing members such as light poles. The present invention may have a light source, at least one solar panel, a wind turbine, at least one power storage member, a control panel, and a mounting frame. The components of the present invention may be water proof and may require no maintenance once installed.

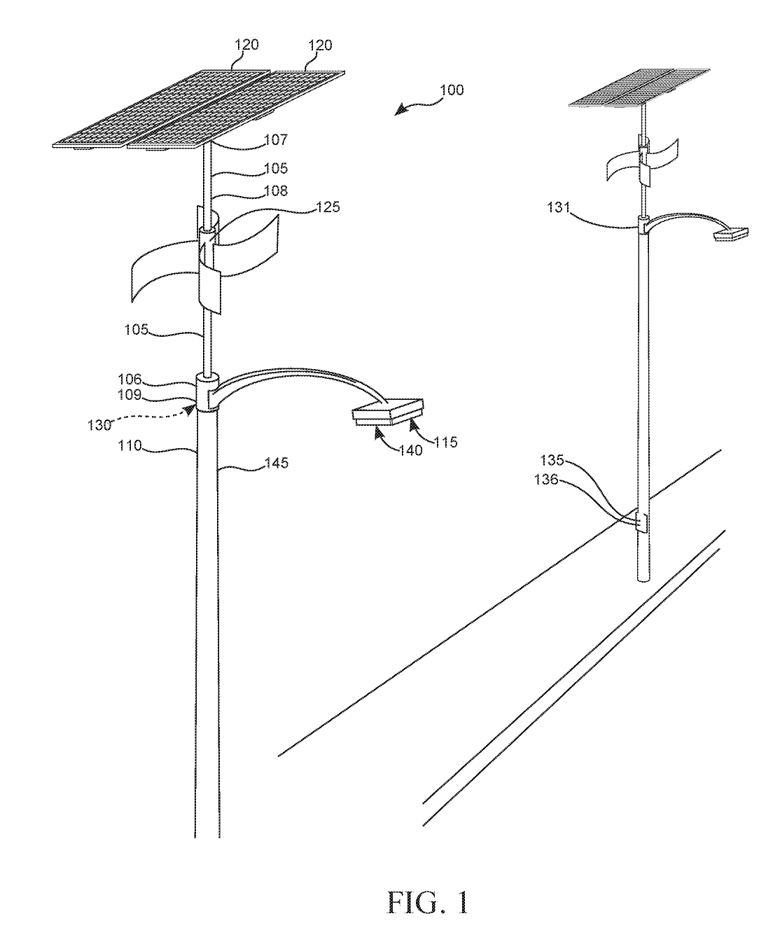

In greater detail now, referring to the drawings by numerals of reference there is shown in FIG. 1, a perspective view illustrating universal lighting system 100 according to an embodiment of the present invention.

Universal lighting system 100 may comprise mounting frame 105 releasably attachable to supporting structure 110, light member 115 attached to mounting frame 105, at least one solar panel member 120 attached to mounting frame 105 that is electrically connected to light member 115 to thereby provide electric power thereto, and wind turbine member 125 attached to mounting frame 105 that is electrically connected to light member 115 to thereby provide electric power thereto.

Solar panel member(s) 120 and wind turbine member 125 of the present invention may connect to power storage member 130 to provide an electrical current that may charge power storage member 130. Power storage member 130 may store excess power such that light member 115 may be provided with power for extended periods of time when solar panel member(s) 120 and wind turbine member 125 may be producing less or no power due to the weather.

Power storage member 130 is attached to mounting frame 105 and is electrically connected to light member 115 for storing operating power. Solar panel member 120 and wind turbine member 125 are able to generate power to be to be stored in power storage member 130 and used by light member 115. Control panel 135 is attached to mounting frame 105 and is electrically connected to light member 115, solar panel member(s) 120, wind turbine member 125, and power storage member 130, such that electrical power can be controlled between the devices to optimally charge power storage member 130 with incoming power generated by solar panel member(s) 120 and wind turbine member 125 during daylight hours and to provide output power only during the dark hours. An electric eye may provide a digital signal at a threshold ambient lighting level.

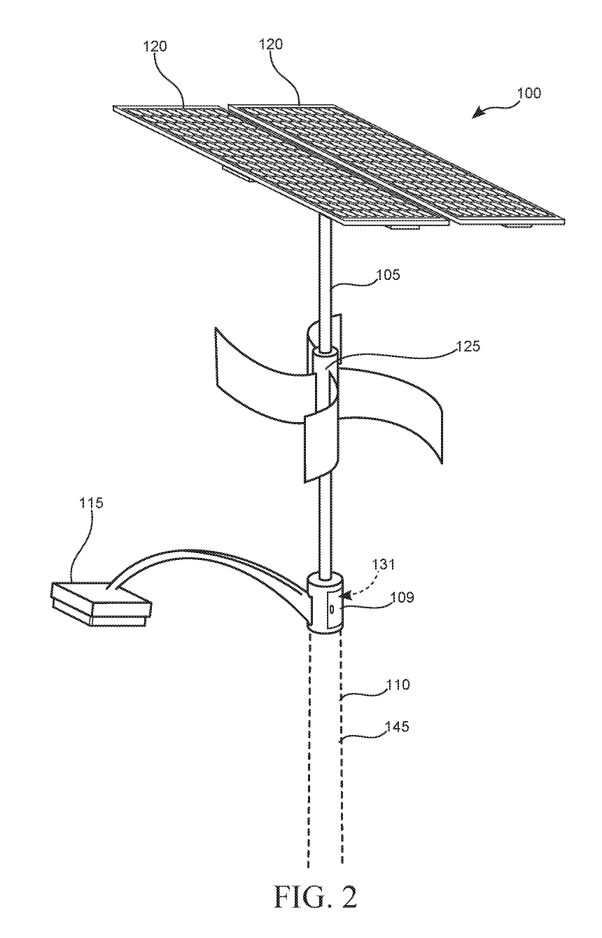

Referring now to FIG. 2, is a perspective view illustrating universal lighting system 100 according to an embodiment of the present invention of FIG. 1.

Light member 115 is formed as light emitting diode 140. Power storage member 130 is formed as rechargeable battery member 131 and rechargeable battery member 131 is formed from the group of rechargeable battery members consisting of lithium ion batteries, lithium polymer batteries, lead acid batteries, nickel-metal hydride batteries, and nickel cadmium batteries. Light member 115 is attached to lower section 106 of mounting frame 105 and solar panel member(s) 120 is attached to top section 107 of mounting frame 105. There may be a plurality of solar panel member(s) 120 attached to top section 107 and side sections 108 of mounting frame 105 in locations where more charging is needed. Wind turbine member 125 may be attached to top section 107 of mounting frame 105 or may be concentrically and rotationally attached within the axis of supporting structure 110. Mounting frame 105 may comprise a rigid load bearing frame that may be designed to rigidly mount the components of the present invention in different configurations in order to conform to the local environment.

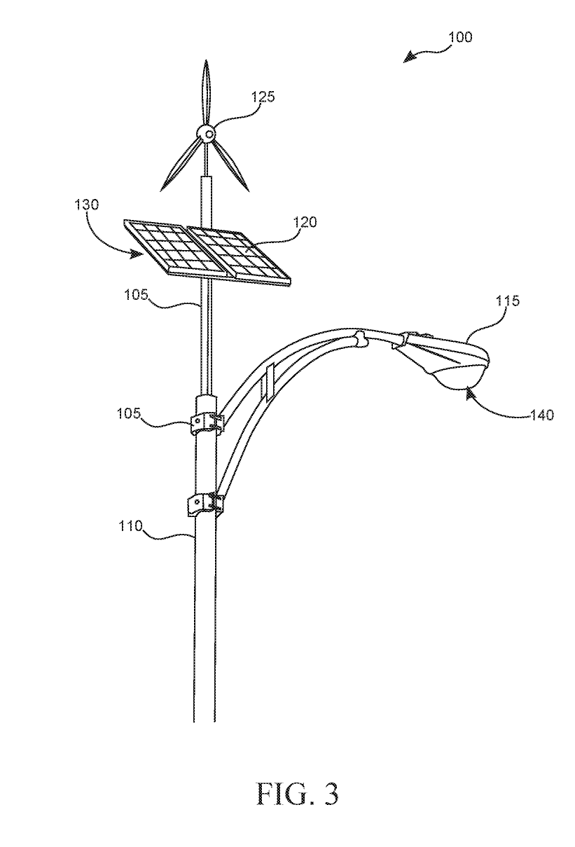

Referring now to FIG. 3, is a perspective view illustrating a second embodiment of the universal lighting system 100 according to an embodiment of the present invention of FIG. 1.

Control panel 135 includes computer circuitry 136 including computer software thereon adapted to control the amount of power provided from solar panel member(s) 120 and wind turbine member 125 to light member 115, and is adapted to obtain, calculate, and provide power storage information. Control panel 135 is attached to back section 109 of mounting frame 105. Mounting frame 105 has a substantially cylindrical shape adapted to be releasably mounted to light pole 145. Mounting frame 105 is formed from a material chosen from the group of materials consisting of aluminum, steel, plastic, and ceramic and the light emitting diode is formed from a waterproof material.

Upon reading this specification, it should be appreciated that, under appropriate circumstances, considering such issues as design preference, user preferences, marketing preferences, cost, structural requirements, available materials, technological advances, etc., other contents as may be sold in a kit, or arrangements such as, for example, including more or less components, customized parts, different color combinations, parts may be sold separately, etc., may be sufficient.

Those with ordinary skill in the art will now appreciate that upon reading this specification and by their understanding the art of renewable energy devices as described herein, the functioning of universal lighting system will be understood by those knowledgeable in such art.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A universal lighting system comprising:
a mounting frame;
wherein said mounting frame is releasably attachable to a supporting structure;
a light member;
wherein said light member is attached to said mounting frame;
at least one solar panel member;
wherein said at least one solar panel member is attached to said mounting frame and is electrically connected to said light member to thereby provide electric power thereto; and
a wind turbine member;
wherein said wind turbine member is attached to said mounting frame and is electrically connected to said light member to thereby provide electric power thereto.

2. The universal lighting system of claim 1, further comprising a power storage member attached to said mounting frame and is electrically connected to said light member, said at least one solar panel member, and said turbine member, such that electrical power can be obtained from said at least one solar panel member and said turbine member and stored therein to be used by said light member.

3. The universal lighting system of claim 2, further comprising a control panel attached to said mounting frame and is electrically connected to said light member, said at least one solar panel member, said turbine member, and said power storage member, such that electrical power can be controlled between said at least one solar panel member, said turbine member, said power storage member, and said light member.

4. The universal lighting system of claim 1, wherein said light member is formed as a light emitting diode.

5. The universal lighting system of claim 1, wherein said power storage member is formed as a rechargeable battery member.

6. The universal lighting system of claim 1, wherein said rechargeable battery member is formed from a group of rechargeable battery members consisting of lithium ion batteries, lithium polymer batteries, lead acid batteries, nickel-metal hydride batteries, and nickel cadmium batteries.

7. The universal lighting system of claim 1, wherein said light member is attached to a lower section of said mounting frame.

8. The universal lighting system of claim 7, wherein said at least one solar panel member is attached to a top section of said mounting frame.

9. The universal lighting system of claim 8, wherein there are a plurality of solar panel members attached to top and side sections of said mounting frame.

10. The universal lighting system of claim 7, wherein said wind turbine is attached to said top section of said mounting frame.

11. The universal lighting system of claim 3, wherein said control panel includes computer circuitry including computer software thereon adapted to control the amount of power provided from said at least one solar panel and said wind turbine member to said light member, and is adapted to obtain, calculate, and provide power storage information.

12. The universal lighting system of claim 11, wherein said control panel is attached to a back section of said mounting frame.

13. The universal lighting system of claim 11, wherein said mounting frame has a substantially cylindrical shape adapted to be releasably mounted to a light pole.

14. The universal lighting system of claim 13, wherein said mounting frame is formed from a material chosen from a group of materials consisting of aluminum, steel, plastic, and ceramic.

15. The universal lighting system of claim 4, wherein said light emitting diode is formed from a waterproof material.
